(19) United States
(12) Patent Application Publication
(10) Pub. No.: US 2024/0406783 A1
(43) Pub. Date: Dec. 5, 2024

(54) DATA PROCESSING METHOD AND APPARATUS, COMPUTER READABLE MEDIUM, AND TERMINAL DEVICE

(71) Applicant: TENCENT TECHNOLOGY (SHENZHEN) COMPANY LIMITED, Shenzhen (CN)

(72) Inventor: Yixue LEI, Shenzhen (CN)

(73) Assignee: TENCENT TECHNOLOGY (SHENZHEN) COMPANY LIMITED, Shenzhen (CN)

(21) Appl. No.: 18/804,338

(22) Filed: Aug. 14, 2024

Related U.S. Application Data
(63) Continuation of application No. PCT/CN2022/142049, filed on Dec. 26, 2022.

(30) Foreign Application Priority Data
May 6, 2022 (CN) 202210488311.1

(51) Int. Cl. H04W 28/02; H04W 60/00

(52) U.S. Cl. CPC H04W 28/0231; H04W 60/00

(57) ABSTRACT

A data processing method, performed by a terminal device, includes: negotiating first processing capability information for a service data packet set with a network-side device; and communicating with the network-side device based on the first processing capability information, wherein the service data packet set includes associated service data packets, and wherein the communicating with the network-side device includes processing the associated service data packets.

### CROSS-REFERENCE TO RELATED APPLICATIONS

This application is a continuation application of International Application No. PCT/CN2022/142049 filed on Dec. 26, 2022, which claims priority to Chinese Patent Application No. 202210488311.1, filed with the China National Intellectual Property Administration on May 6, 2022, the disclosures of each being incorporated by reference herein in their entireties.

### FIELD

The disclosure relates to the field of computer and communication technologies, and to a data processing method and apparatus, a computer-readable medium, and a terminal device.

### BACKGROUND

In 5th-Generation (5G) and evolved 5G systems, high-bandwidth interactive services are an important type of services, such as cloud gaming, virtual reality (VR), augmented reality (AR), mixed reality (MR), extended reality (XR), and cinematic reality (CR).

These high-bandwidth interactive services not only require high transmission timeliness, but also have a greatly increased volume of data generated at an application layer, with the increase of resolution, frame rate, degree of freedom, and other indicators. The data packet content generated at the application layer of such services may need to be divided into a large quantity of data packet segments with a very low delay for transmission. Therefore, how to control efficient processing of data packets during segmented transmission is a technical problem that needs to be urgently resolved.

### SUMMARY

Provided are a data processing method and apparatus, a computer-readable medium, and a terminal device.

Other features and advantages are apparent through review of the following descriptions.

According to some embodiments, a data processing method, performed by a terminal device, includes: negotiating first processing capability information for a service data packet set with a network-side device; and communicating with the network-side device based on the first processing capability information, wherein the service data packet set includes a plurality of associated service data packets, and wherein the communicating with the network-side device includes processing the plurality of associated service data packets.

According to some embodiments, a data processing apparatus includes: at least one memory configured to store computer program code; at least one processor configured to read the program code and operate as instructed by the program code, the program code including: negotiation code configured to cause at least one of the at least one processor to negotiate first processing capability information for a service data packet set with a network-side device; and processing code configured to cause at least one of the at least one processor to communicate with the network-side device based on the first processing capability information, wherein the service data packet set includes a plurality of associated service data packets, and wherein the processing code is configured to process the plurality of associated service data packets in the communication with the network-side device.

According to some embodiments, a non-transitory computer-readable medium, storing computer code which, when executed by at least one processor, causes the at least one processor to at least: negotiate first processing capability information for a service data packet set with a network-side device; and communicate with the network-side device based on the first processing capability information, wherein the service data packet set includes a plurality of associated service data packets, and wherein the communication with the network-side device includes processing the plurality of associated service data packets.

The foregoing and following descriptions are for illustration and explanation purposes, and are not intended to limit the scope of the disclosure.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture according to some embodiments.

FIG. 2 is a schematic diagram of a transmission process of a multimedia data packet according to some embodiments.

FIG. 3 is a flowchart of a data processing method according to some embodiments.

FIG. 4 is a flowchart of a data processing method according to some embodiments.

FIG. 5 is a flowchart of a data processing method according to some embodiments.

FIG. 6 is a flowchart of a data processing method according to some embodiments.

FIG. 7 is a block diagram of a data processing apparatus according to some embodiments.

FIG. 8 is a schematic diagram of a structure of a computer system of a terminal device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

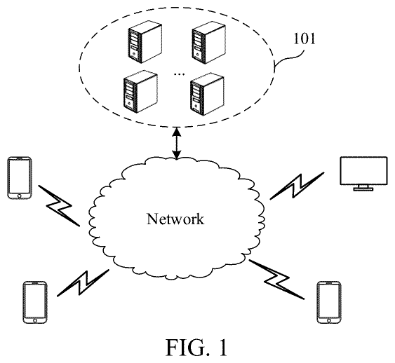

For example, in a cloud gaming scenario shown in FIG. 1, a cloud server 101 may be configured to run a cloud game. The cloud server 101 may render a game picture, perform encoding processing on an audio signal and a rendered image, and finally transmit, to game clients through a network, encoded data obtained through the encoding processing. The game client may be user equipment (UE) with a streaming media playing capability, a human-computer interaction capability, and a communication capability, such as a smartphone, a tablet computer, a notebook computer, a desktop computer, a smart television, a smart home, an on-board terminal, or an aerial vehicle. The game client may be an application running in a terminal device. The game client may decode the encoded data transmitted by the cloud server 101, to obtain analog audio and video signals, and play the analog audio and video signals.

FIG. 1 shows an exemplary system architecture of a cloud gaming system, and may not limit an architecture of the cloud gaming system. For example, in some embodiments, the cloud gaming system may further include a back-end server for scheduling, and the like. In addition, the cloud server 101 may be an independent physical server, or may be a server cluster or distributed system including a plurality of physical servers, or may be a cloud server providing cloud computing services such as cloud services, cloud databases, cloud computing, cloud functions, cloud storage, network services, cloud communication, middleware services, domain name services, security services, content delivery networks (CDNs), and big data and artificial intelligence platforms. The game client and the cloud server 101 may be directly or indirectly connected through wired or wireless communication. The disclosure is not limited thereto.

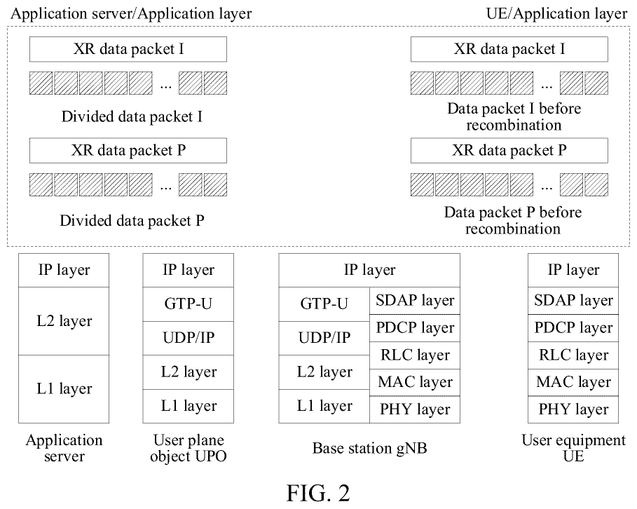

In the various multimedia-based interactive service application scenarios, a multimedia data packet may be large and therefore may need to be split into a plurality of data packets for transmission. As shown in FIG. 2, in a 5G system, a user plane may include an application server, a user plane object (UPO) (or sometimes referred to as a “user plane function” (UPF) by the 3rd Generation Partnership Project (3GPP), for example), a base station (next generation NodeB, gNB for short), and UE. For some service scenarios, transmission of a multimedia data packet may be in a downlink direction, for example, from the application server to the UPO, and the multimedia data packet is sent to the UE by using the gNB. Processing performed by the application server may be performed by an application-side network element at the application layer, and for example, may be an application object (AO) (or sometimes referred to as an “application function” (AF) by the 3GPP, for example). During transmission, the multimedia data packet (using an XR data packet as an example in FIG. 2) is split at the application layer of the application server. Data packets obtained through splitting are used as internet protocol (IP) packets and are transmitted from the application server to the UPO. The 5G system transmits the sub-data packets to the UE side through a protocol data session for a protocol data unit (PDU) (or sometimes referred to as a “PDU session” by the 3GPP, for example). The UE side submits the sub-data packets upward level by level from a protocol stack and recombines the sub-data packets, to recover the multimedia data packet.

In the system shown in FIG. 2, an L1 layer may be a physical layer, configured for allowing original data to be transmitted on various physical media; an L2 layer is a data link layer, and the data link layer provides a service for a network layer based on a service provided by the physical layer; an IP layer is the network layer, configured for data transfer between two end systems; UDP stands for user datagram protocol; GTP-U stands for general packet radio service (GPRS) tunneling protocol-user plane; PHY stands for physical; MAC stands for media access control; RLC stands for radio link control; PDCP stands for packet data convergence protocol; and SDAP stands for service data adaptation protocol.

A multimedia service may divide a frame of multimedia data packet into a plurality of data packets for transmission. However, if these data packets are transmitted in a network, the network may not distinguish an association relationship between these data packets, and the association relationship may not be referred to such that a packet may be discarded based on network congestion. If a processing mechanism for service data packets (for example, a service data packet set, which may also be referred to as a PDU set) with associativity is introduced, a terminal device and a network device may need to agree on a capability for processing these service data packets with associativity, and implement the capability through a new signaling procedure. However, such features cannot be implemented based on current technologies.

Based on these problems, some embodiments provide a new data processing solution, to enable the terminal device and the network device to perform negotiation with respect to whether to support processing on the service data packet set (for example, the PDU set) and how to support the processing on the service data packet set, and to provide a signaling processing procedure that supports the negotiation process, to control efficiency of processing the service data packets is improved by processing the service data packet set.

Details of some embodiments are described as follows:

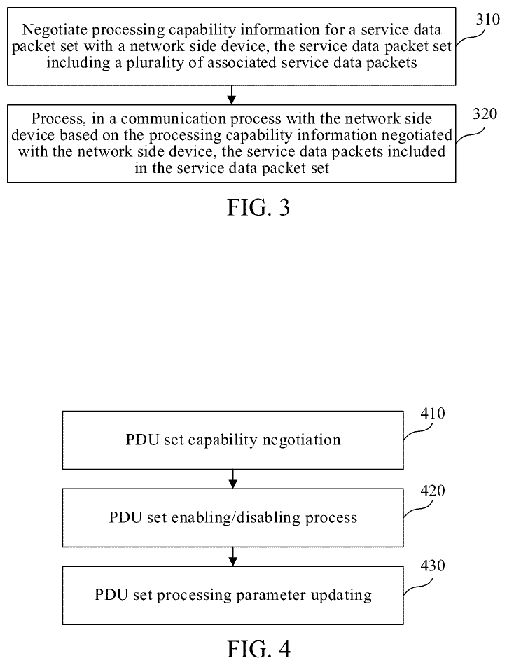

FIG. 3 is a flowchart of a data processing method according to some embodiments. The data processing method may be performed by a terminal device. As shown in FIG. 3, the data processing method may include 310 and 320, which are described as follows:

310: Negotiate processing capability information for a service data packet set with a network-side device, the service data packet set including a plurality of associated service data packets.

320: Process, in a communication process with the network-side device based on the processing capability information negotiated with the network-side device, the service data packets included in the service data packet set.

For 310, some embodiments are described for the terminal device to negotiate the processing capability information for the service data packet set with the network-side device.

According to some embodiments, the terminal device may generate a registration request, the registration request including processing capability information of the terminal device for the service data packet set, and send the registration request to the network-side device, to negotiate the processing capability information for the service data packet set with the network-side device. In some embodiments, the network-side device may include an access network device, for example, a base station device; and the network-side device may further include a core network device, for example, an access and mobility management object (AMO) (or sometimes referred to as an “access and mobility management function” (AMF) by the 3GPP, for example). The network-side device may also include a session management object (SMO) (or sometimes referred to as a “session management function” (SMF) by the 3GPP, for example), a policy control object (PCO) (or sometimes referred to as a “policy control function” (PCF) by the 3GPP, for example), or a network exposure object (NEO) (or sometimes referred to as a “network exposure function” (NEF) by the 3GPP, for example).

According to some embodiments, the terminal device negotiates the processing capability information for the service data packet set with the network-side device based on the registration request. In some embodiments, the registration request further indicates to enable processing of the service data packet set. Negotiating the processing capability information for the service data packet set and determining whether to enable the processing of the service data packet set may be combined in the registration request. The terminal device negotiates the processing capability information for the service data packet set with the network-side device based on the registration request. The registration request is further configured for enabling the processing of the service data packet set. A signaling interaction for negotiating the processing capability information may not be performed, signaling overhead of the terminal device may be reduced, and information transmission resources between the terminal device and the network-side device may be saved.

In the application scenario in which the process of negotiating the processing capability information for the service data packet set and the process of determining whether to enable the processing of the service data packet set are combined in the registration request, if the processing capability information of the terminal device for the service data packet set is to be updated, a new registration request may be generated, the new registration request including updated processing capability information of the terminal device, and the new registration request is sent to the network-side device, to update the processing capability information of the terminal device for the service data packet set. The terminal device may generate a new registration request to update the processing capability information for the service data packet set.

According to some embodiments, the terminal device may generate a registration request, the registration request including processing capability information of the terminal device for the service data packet set, and send the registration request to the network-side device, to negotiate the processing capability information for the service data packet set with the network-side device. The terminal device sends the registration request to the network-side device, so that the network-side device learns the processing capability information of the terminal device for the service data packet set, for the terminal device to process, based on the negotiated processing capability information adapted to the terminal device, service data packets included in the service data packet set. In addition, the terminal device may generate a protocol data session establishment request. The protocol data session establishment request includes indication information for enabling or disabling processing of the service data packet set. The protocol data session establishment request is sent to the network-side device, to indicate to enable or disable the processing of the service data packet set. Negotiating the processing capability information for the service data packet set and determining whether to enable/disable the processing of the service data packet set may be separately performed, and for example, may be performed respectively in the registration request and the protocol data session establishment request. Based on a determination not to perform enabling or disabling of the processing of the service data packet set, the terminal device and the network-side device may negotiate the processing capability information for the service data packet set. For example, based on a determination not to process the service data packet set (for example, based on the processing of the service data packet set being disabled), the terminal device and the network-side device may pre-negotiate the processing capability information for the service data packet set to obtain a negotiation result (for example, the processing capability information for the service data packet set). Based on a determination to enable the processing of the service data packet set, the terminal device and the network-side device may directly process, without spending time on negotiation, the service data packets included in the service data packet set based on the pre-determined negotiation result, saving time for processing the service data packets included in the service data packet set, and improving the efficiency of processing the service data packets.

In the application scenario in which the process of negotiating the processing capability information for the service data packet set and the process of determining whether to enable/disable the processing of the service data packet set are performed respectively in the registration request and the protocol data session establishment request, the processing capability information of the terminal device may be updated based on the protocol data session establishment request. The protocol data session establishment request further includes updated processing capability information of the terminal device, and the updated processing capability information may be configured for updating the processing capability information of the terminal device for the service data packet set.

According to some embodiments, the terminal device may generate a protocol data session establishment request, the protocol data session establishment request including processing capability information of the terminal device for the service data packet set, and send the protocol data session establishment request to the network-side device, to negotiate the processing capability information for the service data packet set with the network-side device.

According to some embodiments, the terminal device negotiates the processing capability information for the service data packet set with the network-side device based on the protocol data session establishment request. In some embodiments, the protocol data session establishment request further indicates to enable a processing of the service data packet set. Negotiating the processing capability information for the service data packet set and determining whether to enable the processing of the service data packet set may be combined in the protocol data session establishment request. The terminal device negotiates the processing capability information for the service data packet set with the network-side device based on the protocol data session establishment request. The protocol data session establishment request is further configured for establishing a protocol data session and enabling the processing of the service data packet set, such that separately performing a signaling interaction between the terminal device and the network-side device for negotiating the processing capability information and enabling the processing of the service data packet set may not be performed, reducing signaling overheads of the terminal device, and saving information transmission resources between the terminal device and the network-side device.

In the application scenario in which the process of negotiating the processing capability information for the service data packet set and the process of determining whether to enable the processing of the service data packet set are combined in the protocol data session establishment request, if the processing capability information of the terminal device for the service data packet set is to be updated, a new protocol data session establishment request may be generated, the new protocol data session establishment request including updated processing capability information of the terminal device, and the new protocol data session establishment request is sent to the network-side device, to update the processing capability information of the terminal device for the service data packet set. The terminal device may generate a new protocol data session establishment request to update the processing capability information for the service data packet set.

According to some embodiments, the terminal device may generate a protocol data session establishment request, the protocol data session establishment request including processing capability information of the terminal device for the service data packet set, and send the protocol data session establishment request to the network-side device, to negotiate the processing capability information for the service data packet set with the network-side device. In addition, the terminal device may generate a protocol data session modification request. The protocol data session modification request includes indication information for enabling or disabling a processing of the service data packet set. The protocol data session modification request is sent to the network-side device, to indicate to enable or disable the processing of the service data packet set. Negotiating the processing capability information for the service data packet set and determining whether to enable/disable the processing of the service data packet set may be separately performed, and for example, may be performed respectively in the protocol data session establishment request and the protocol data session modification request.

In the application scenario in which the process of negotiating the processing capability information for the service data packet set and the process of determining whether to enable/disable the processing of the service data packet set are performed respectively in the protocol data session establishment request and the protocol data session modification request, the processing capability information of the terminal device may be updated based on the protocol data session modification request. The protocol data session modification request further includes updated processing capability information of the terminal device, and the updated processing capability information may be configured for updating the processing capability information of the terminal device for the service data packet set. The processing capability information of the terminal device is updated in time based on the protocol data session modification request, which avoids processing the service data packets based on obsolete processing capability information of the terminal device, and may control adaptability between a manner of processing the service data packets and current processing capability information of the terminal device, avoiding a negative impact such as an incorrect service data packet loss caused by a change of the processing capability information of the terminal device, and improving stability of processing the service data packets.

According to some embodiments, the terminal device may generate a protocol data session establishment request, the protocol data session establishment request including processing capability information of the terminal device for the service data packet set, and send the protocol data session establishment request to the network-side device, to negotiate the processing capability information for the service data packet set with the network-side device. In addition, the terminal device may generate a new protocol data session establishment request. The new protocol data session establishment request includes indication information for enabling or disabling processing of the service data packet set. The new protocol data session establishment request is sent to the network-side device, to indicate to enable or disable the processing of the service data packet set. Negotiating the processing capability information for the service data packet set and determining whether to enable/disable the processing of the service data packet set may be separately performed, and for example, may be performed respectively in the protocol data session establishment request and the new protocol data session establishment request. The process of negotiating the processing capability information for the service data packet set and the process of determining whether to enable/disable the processing of the service data packet set may be separately performed without keeping in synchronization, thereby improving efficiency of processing the service data packet set.

In the application scenario in which the process of negotiating the processing capability information for the service data packet set and the process of determining whether to enable/disable the processing of the service data packet set are performed respectively in the protocol data session establishment request and the new protocol data session establishment request, the processing capability information of the terminal device may be updated based on the new protocol data session establishment request. The new protocol data session establishment request further includes updated processing capability information of the terminal device, and the updated processing capability information may be configured for updating the processing capability information of the terminal device for the service data packet set.

In some embodiments, the process for the terminal device and the network-side device to negotiate the processing capability information for the service data packet set may be as follows: The processing capability information of the terminal device for the service data packet set is added into a terminal device capability parameter (for example, UE capability), to negotiate the processing capability information for the service data packet set with the network-side device. The processing capability information of the terminal device for the service data packet set may be learned by reading the terminal device capability parameter, and a capability parameter of the terminal device may also be learned, thereby improving efficiency of obtaining information of the terminal device capability parameter. In some embodiments, processing capability information of the terminal device for the service data packet set on a radio access network side may be added into a radio access capability parameter of the terminal device, and processing capability information of the terminal device for the service data packet set on a core network side may be added into a core network capability parameter of the terminal device. The processing capability information of the terminal device for the service data packet set on the radio access network side and the processing capability information of the terminal device for the service data packet set on the core network side are respectively stored in the corresponding capability parameters, thereby improving storage organization and relevance of the processing capability information of the terminal device for the service data packet set, and avoiding information interference caused by storing various information in one place.

According to some embodiments, the indication information for enabling or disabling the processing of the service data packet set includes enabling or disabling at least one of the following: recognizing the service data packets included in the service data packet set; performing processing based on at least one of priorities and quality of service (QOS) of the service data packets included in the service data packet set; performing processing based on at least one of priorities and QoS between service data packet sets; and recovering corresponding multimedia content of the service data packet set based on a packet loss. A plurality of processing functions of the terminal device may be enabled or disabled at the same time, thereby improving efficiency of controlling the functions of the terminal device.

In some embodiments, recognizing the service data packets included in the service data packet set is recognizing that a service data packet belongs to the service data packets included in the service data packet set; performing processing based on at least one of priorities and QoS of the service data packets included in the service data packet set may be that processing of a service data packet with a high priority or high QoS is controlled, and a service data packet with a low priority or low QoS may be discarded based on network congestion; performing processing based on at least one of priorities and QoS between service data packet sets may be that processing of a service data packet set (PDU set) with a high priority or high QoS is controlled, and a service data packet set with a low priority or low QoS may be discarded based on network congestion; and recovering corresponding multimedia content of the service data packet set based on a packet loss may be that the corresponding multimedia content may be recovered based on a service data packet that is not lost after the packet loss (for example, a service data packet with a low priority or low QoS is lost).

According to some embodiments, the indication information for enabling or disabling the processing of the service data packet set includes enabling or disabling at least one of the following from the network-side device: recognizing the service data packets included in the service data packet set; forwarding the service data packets included in the service data packet set and detecting QoS information; and selectively discarding, based on network congestion, based on a ranking difference between the service data packets included in the service data packet set, a service data packet that may not affect data recovery. A plurality of processing features of the network-side device may be enabled or disabled at the same time, thereby improving efficiency of controlling the network-side device.

In some embodiments, recognizing the service data packets included in the service data packet set is recognizing that a service data packet belongs to the service data packets included in the service data packet set; forwarding the service data packets included in the service data packet set and detecting QoS information may be that a delay, jitter, transmission rate, and the like may be detected during transmission of the service data packets; and selectively discarding, based on network congestion, based on a ranking difference between the service data packets included in the service data packet set, a service data packet that may not affect data recovery may be that the corresponding multimedia content may be recovered based on a service data packet that is not lost after the packet loss (for example, a service data packet with a low priority or low QoS is lost).

According to some embodiments, the processing capability information includes a processing capability of the terminal device for the service data packet set, and the processing capability of the terminal device for the service data packet set includes at least one of the following: whether the terminal device is capable of recognizing the service data packets included in the service data packet set; whether the terminal device is capable of performing processing based on at least one of priorities and QoS of the service data packets included in the service data packet set; whether the terminal device is capable of performing processing based on at least one of priorities and QoS between service data packet sets; and whether the terminal device is capable of recovering corresponding multimedia content of the service data packet set based on a packet loss. There may be various processing capabilities of the terminal device for negotiation, thereby improving inclusiveness of the processing capability information, and further expanding an application range of capability information negotiation.

According to some embodiments, the processing capability information includes a processing capability of the network-side device for the service data packet set, and the processing capability of the network-side device for the service data packet set includes at least one of the following: whether the network-side device is capable of recognizing the service data packets included in the service data packet set; whether the network-side device is capable of forwarding the service data packets included in the service data packet set and detecting QoS information; and whether the network-side device is capable of selectively discarding, based on network congestion, based on a ranking difference between the service data packets included in the service data packet set, a service data packet that may not affect data recovery. There may be various processing capabilities of the network-side device for negotiation, thereby improving inclusiveness of the processing capability information, and further expanding an application range of capability information negotiation.

According to some embodiments shown in FIG. 3, the processing capability information for the service data packet set may be negotiated to process the service data packet set, so that efficiency of processing the service data packets may be improved through the processing on the service data packet set.

As shown in FIG. 4, a data processing method according to some embodiments may include the following three procedures:

410: PDU set capability negotiation process.

420: PDU set enabling/disabling process.

430: PDU set processing parameter updating process.

In 410, the content of the PDU set capability negotiation process includes, but is not limited to: whether a terminal device has a capability of supporting the PDU set and whether a network-side device has a capability of supporting the PDU set.

According to some embodiments, whether the terminal device has the capability of supporting the PDU set includes, but is not limited to: whether the terminal device has a capability of recognizing a series of data packets in the PDU set and performing processing based on priority and QoS characteristics in the PDU set and between PDU sets; and whether the terminal device may recover multimedia content based on a decoding algorithm based on a partial packet loss occurring in the PDU set.

According to some embodiments, whether the network-side device has the capability of supporting the PDU set includes, but is not limited to: whether the network-side device may recognize a series of data packets in the PDU set, perform forwarding, and monitor based on QoS satisfaction including a delay, jitter, rate, and the like; and whether the network-side device may selectively discard, based on congestion, based on a ranking difference between the data packets in the PDU set, a data packet that may not affect data decoding.

According to some embodiments, for PDU set capability negotiation, from the perspective of the UE (for example, the terminal device), based on the UE initiating the capability negotiation, the capability information of the PDU set may be used as a part of the UE capability, for interaction between the UE and the core network; and from the perspective of an end-to-end signaling procedure, a new parameter is added into the existing UE capability negotiation procedure to indicate the capability information of the PDU set of the UE.

In 420, the PDU set enabling/disabling process is involved.

According to some embodiments, the PDU set capability negotiation process and the PDU set enabling/disabling process may be separated or may be combined.

If the PDU set capability negotiation process and the PDU set enabling/disabling process are separated, the PDU set capability negotiation process may be performed in combination with a UE registration process or a protocol data session establishment process; and the PDU set enabling/disabling process may be together with a protocol data session updating process. The PDU set capability negotiation process may be performed in combination with a protocol data session establishment process, and the PDU set enabling/disabling process may be performed by establishing a new protocol data session.

If the PDU set capability negotiation process and the PDU set enabling/disabling process are combined, the PDU set capability negotiation process may be directly performed in a UE registration process or a protocol data session establishment process, and a PDU set processing may be enabled.

According to some embodiments, if the PDU set capability negotiation process and the PDU set enabling/disabling process are separated, the PDU set enabling/disabling process is applicable to both the network-side device and the terminal device.

For the network-side device, the PDU set enabling/disabling process includes, but is not limited to: enabling/disabling recognizing a series of data packets in the PDU set and performing forwarding; enabling/disabling monitoring based on QoS satisfaction including a delay, jitter, rate, and the like; and enabling/disabling selectively discarding, based on network congestion, based on a ranking difference between the data packets in the PDU set, a data packet that may not affect data decoding.

For the terminal device, the PDU set enabling/disabling process includes, but is not limited to: enabling/disabling a capability of recognizing a series of data packets in the PDU set and performing processing based on priority and QoS characteristics in the PDU set and between PDU sets; and enabling/disabling recovering multimedia content based on a decoding algorithm based on a partial packet loss occurring in the PDU set.

In 430, the PDU set processing parameter updating process may be involved.

According to some embodiments, the PDU set processing parameter updating process includes parameter updating on the network-side device and parameter updating on the terminal device side. In some embodiments, the parameter updating on the terminal device side may be performed based on a UE route selection policy (URSP).

According to some embodiments, the PDU set processing parameter updating process includes, but is not limited to:

updating a parameter related to a PDU set recognition mechanism, including updating a rule for recognizing the PDU set, and the rule may be associated with multimedia encoding and decoding, for example, H.264 or H.265;
updating a QoS monitoring characteristic parameter of the PDU set, including but not limited to monitoring, and reporting content and frequency of bandwidth, delay, jitter, and other parameters; and
updating a processing rule of the data packets based on ranking of the data packets in the PDU set based on network congestion.

According to some embodiments, a UE-side PDU set capability includes a UE radio access capability and a UE core network capability. A related capability parameter of the PDU set on the radio side is stored in the UE radio access capability. A capability parameter of the PDU set on the core network may be stored in a session management (SM) core network capability or in a mobility management (MM) core network capability.

The following describes an application scenario with reference to the accompanying drawings:

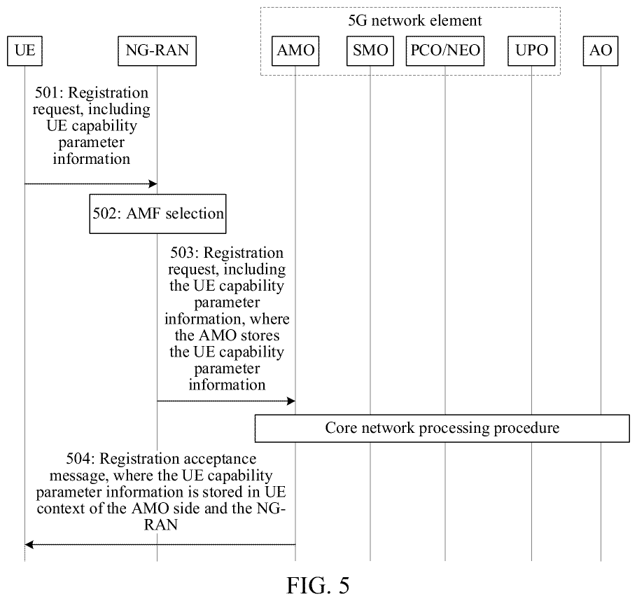

As shown in FIG. 5, a data processing method according to some embodiments include the following operations:

501: The UE sends a registration request to the NG-radio access network (NG-RAN), and the registration request includes UE capability parameter information.

The UE capability parameter information includes a capability parameter related to PDU set processing on an air interface side of the UE and a capability parameter related to PDU set processing of a core network.

502: The NG-RAN performs AMO selection. In addition, the NG-RAN stores, in the NG-RAN, a radio access side capability parameter related to PDU set processing of the UE.

503: Send the registration request from the NG-RAN to the AMO, and the registration request includes the PDU set capability parameter information of the UE, and the AMO stores the UE capability parameter information.

504: Based on the core network processing the registration request of the UE and accepting UE registration, the AMO sends a registration acceptance message to the UE, to confirm that the UE is successfully registered. The PDU set capability parameter information of the UE may be stored in UE context of the AMO side and the NG-RAN.

According to some embodiments shown in FIG. 5, a PDU set capability negotiation process is performed in the registration request of the UE, and the PDU set capability negotiation process is understood as that the UE has enabled a corresponding feature of the PDU set, and the PDU set enabling and disabling may not be performed. The UE capability parameter is not updated based on the terminal device changing between an inactive state and a connected state. The PDU set capability negotiation process and the UE registration process may be combined, a PDU set capability parameter updating process may be completed by re-registration.

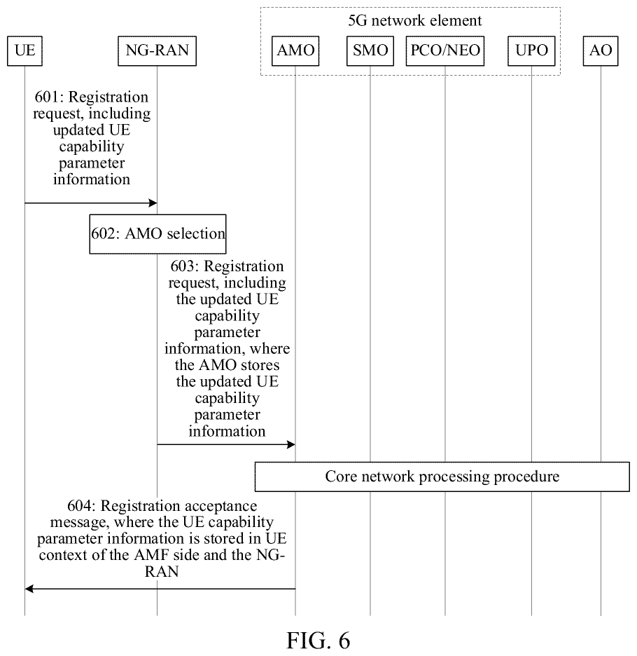

As shown in FIG. 6, a data processing method according to some embodiments include the following operations:

601: The UE sends a registration request to the NG-RAN, and the registration request includes updated UE capability parameter information. The updated UE capability parameter information includes an updated capability parameter related to PDU set processing on an air interface side of the UE and a capability parameter related to PDU set processing of a core network.

602: The NG-RAN performs AMO selection. In addition, the NG-RAN stores, in the NG-RAN, an updated radio access side capability parameter related to PDU set processing of the UE.

603: Send the registration request from the NG-RAN to the AMO, and the registration request includes the updated PDU set capability parameter information of the UE, and the AMO stores the updated UE capability parameter information.

604: Based on the core network processing the registration request of the UE and accepting UE registration, the AMO sends a registration acceptance message to the UE, to confirm that the UE is successfully registered. The updated PDU set capability parameter information of the UE may be stored in UE context of the AMO side and the NG-RAN.

According to some embodiments, if the PDU set capability negotiation process and the PDU set enabling/disabling process are separated, the PDU set enabling/disabling process may be performed in a protocol data session modification procedure based on a protocol data session being established, or may be completed by reestablishing a protocol data session process. For example, indication information for enabling the PDU set of the UE may be added into a protocol data session establishment message, and the indication information for enabling the PDU set of the UE is also added into an N4 session between the session management object (SMO) (or sometimes referred to as a “session management function” (SMF) by the 3GPP, for example) and the UPO.

According to some embodiments, the terminal device and the network device perform negotiation with respect to whether to support processing on the service data packet set (for example, the PDU set) and how to support the processing on the service data packet set, and provide a signaling processing procedure that supports the negotiation process, to control efficiency of processing the service data packets is improved by processing the service data packet set.

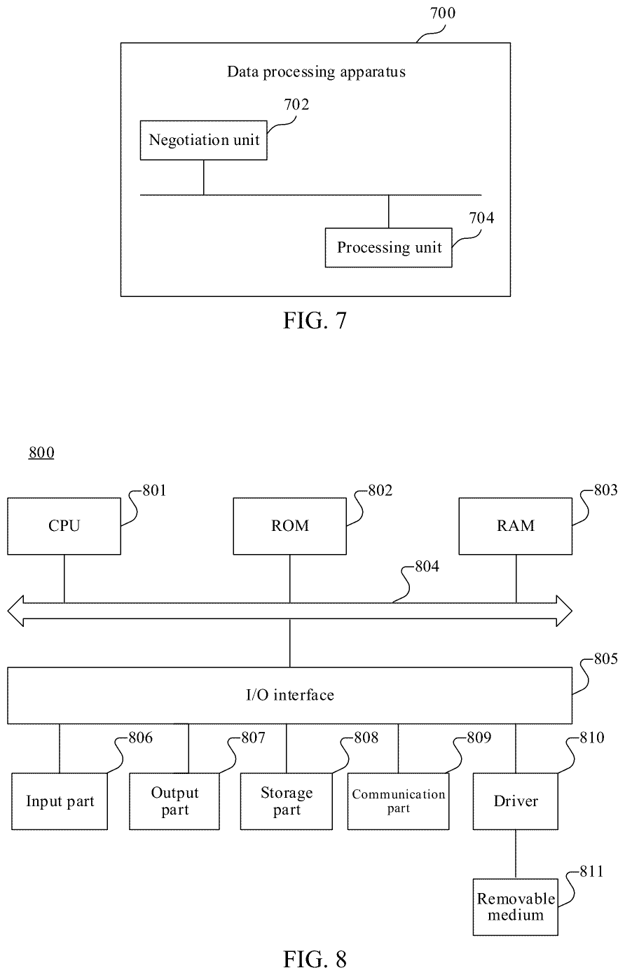

FIG. 7 is a block diagram of a data processing apparatus according to some embodiments. The data processing apparatus may be configured in a terminal device.

As shown in FIG. 7, a data processing apparatus 700 according to some embodiments include: a negotiation unit 702 and a processing unit 704.

The negotiation unit 702 may be configured to negotiate processing capability information for a service data packet set with a network-side device, the service data packet set including a plurality of associated service data packets. The processing unit 704 may be configured to process, in a communication process with the network-side device based on the processing capability information, the service data packets included in the service data packet set.

According to some embodiments, the negotiation unit 702 may be configured to: generate a registration request, the registration request including processing capability information of the terminal device for the service data packet set; and transmit the registration request to the network-side device, to negotiate the processing capability information for the service data packet set with the network-side device.

According to some embodiments, the registration request further indicates to enable processing of the service data packet set.

According to some embodiments, the negotiation unit 702 is further configured to: generate a new registration request if the processing capability information of the terminal device for the service data packet set is to be updated, the new registration request including updated processing capability information of the terminal device; and transmit the new registration request to the network-side device, to update the processing capability information of the terminal device for the service data packet set.

According to some embodiments, the data processing apparatus 700 further includes: a generation unit, configured to generate a protocol data session establishment request, the protocol data session establishment request including indication information for enabling or disabling processing of the service data packet set; and a transmitting unit, configured to transmit the protocol data session establishment request to the network-side device, to indicate to enable or disable the processing of the service data packet set.

According to some embodiments, the protocol data session establishment request further includes updated processing capability information of the terminal device, and the updated processing capability information may be configured for updating the processing capability information of the terminal device for the service data packet set.

According to some embodiments, the negotiation unit 702 may be configured to: generate a protocol data session establishment request, the protocol data session establishment request including processing capability information of the terminal device for the service data packet set; and transmit the protocol data session establishment request to the network-side device, to negotiate the processing capability information for the service data packet set with the network-side device.

According to some embodiments, the protocol data session establishment request further indicates to enable processing of the service data packet set.

According to some embodiments, the negotiation unit 702 is further configured to: generate a new protocol data session establishment request if the processing capability information of the terminal device for the service data packet set is to be updated, the new protocol data session establishment request including updated processing capability information of the terminal device; and transmit the new protocol data session establishment request to the network-side device, to update the processing capability information of the terminal device for the service data packet set.

According to some embodiments, the data processing apparatus 700 further includes: a generation unit, configured to generate a protocol data session modification request, the protocol data session modification request including indication information for enabling or disabling processing of the service data packet set; and a transmitting unit, configured to transmit the protocol data session modification request to the network-side device, to indicate to enable or disable the processing of the service data packet set.

According to some embodiments, the protocol data session modification request further includes updated processing capability information of the terminal device, and the updated processing capability information may be configured for updating the processing capability information of the terminal device for the service data packet set.

According to some embodiments, the data processing apparatus 700 further includes: a generation unit, configured to generate a new protocol data session establishment request, the new protocol data session establishment request including indication information for enabling or disabling processing of the service data packet set; and a transmitting unit, configured to transmit the new protocol data session establishment request to the network-side device, to indicate to enable or disable the processing of the service data packet set.

According to some embodiments, the new protocol data session establishment request further includes updated processing capability information of the terminal device, and the updated processing capability information may be configured for updating the processing capability information of the terminal device for the service data packet set.

According to some embodiments, the negotiation unit 702 may be configured to: add processing capability information of the terminal device for the service data packet set into a terminal device capability parameter, to negotiate the processing capability information for the service data packet set with the network-side device.

According to some embodiments, the negotiation unit 702 may be configured to: add processing capability information of the terminal device for the service data packet set on a radio access network side into a radio access capability parameter of the terminal device, and add processing capability information of the terminal device for the service data packet set on a core network side into a core network capability parameter of the terminal device.

According to some embodiments, each unit may exist respectively or be combined into one or more units. Some units may be further split into multiple smaller function subunits, thereby performing the same operations without affecting the technical effects of some embodiments. The units are divided based on logical functions. one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, and the instructions of each unit are executable by a processor to thereby cause the processor to perform the respective operations of the corresponding unit.

According to some embodiments, the indication information for enabling or disabling the processing of the service data packet set includes enabling or disabling at least one of the following processing features of the terminal device: recognizing the service data packets included in the service data packet set; performing processing based on at least one of priorities and QoS of the service data packets included in the service data packet set; performing processing based on at least one of priorities and QoS between service data packet sets; and recovering corresponding multimedia content of the service data packet set based on a packet loss.

According to some embodiments, the indication information for enabling or disabling the processing of the service data packet set includes enabling or disabling at least one of the following processing features of the network-side device: recognizing the service data packets included in the service data packet set; forwarding the service data packets included in the service data packet set and detecting QoS information; and selectively discarding, based on network congestion, based on a ranking difference between the service data packets included in the service data packet set, a service data packet that may not affect data recovery.

According to some embodiments, the processing capability information includes a processing capability of the terminal device for the service data packet set, and the processing capability of the terminal device for the service data packet set includes at least one of the following: whether the terminal device is capable of recognizing the service data packets included in the service data packet set; whether the terminal device is capable of performing processing based on at least one of priorities and QoS of the service data packets included in the service data packet set; whether the terminal device is capable of performing processing based on at least one of priorities and QoS between service data packet sets; and whether the terminal device is capable of recovering corresponding multimedia content of the service data packet set based on a packet loss.

According to some embodiments, the processing capability information includes a processing capability of the network-side device for the service data packet set, and the processing capability of the network-side device for the service data packet set includes at least one of the following: whether the network-side device is capable of recognizing the service data packets included in the service data packet set; whether the network-side device is capable of forwarding the service data packets included in the service data packet set and detecting QoS information; and whether the network-side device is capable of selectively discarding, based on network congestion, based on a ranking difference between the service data packets included in the service data packet set, a service data packet that may not affect data recovery.

FIG. 8 is a schematic diagram of a structure of a computer system of a terminal device according to some embodiments.

A computer system 800 of a terminal device shown in FIG. 8 is an example and shall not constitute any limitation on features and use ranges of the disclosure.

As shown in FIG. 8, the computer system 800 includes a central processing unit (CPU) 801, which may perform various actions and processing based on a program stored in a read-only memory (ROM) 802 or a program loaded from a storage part 808 into a random access memory (RAM) 803, for example, perform the methods in some embodiments. The RAM 803 further stores various programs and data for system operations. The CPU 801, the ROM 802, and the RAM 803 are connected to each other by a bus 804. An input/output (I/O) interface 805 is also connected to the bus 804.

The following components are connected to the I/O interface 805: an input part 806 including a keyboard, a mouse, or the like; an output part 807 including a cathode ray tube (CRT), a liquid crystal display (LCD), a speaker, or the like; the storage part 808 including a hard disk or the like; and a communication part 809 including a network interface card such as a local area network (LAN) card or a modem. The communication part 809 performs communication processing through a network such as the Internet. A driver 810 is also connected to the I/O interface 805. A removable medium 811, such as a magnetic disk, an optical disc, a magneto-optical disk, or a semiconductor memory, is mounted on the driver 810, so that a computer program read from the removable medium is installed into the storage part 808.

According to some embodiments, the processes described with reference to the flowcharts may be implemented as a computer software program. For example, some embodiments include a computer program product. The computer program product includes a computer program stored in a computer-readable medium. The computer program includes a computer program for performing the method shown in the flowchart. According to some embodiments, by using the communication part 809, the computer program may be downloaded and installed from a network, and/or installed from the removable medium 811. Based on the computer program being executed by the CPU 801, various features defined in the system are performed.

The computer-readable medium in some embodiments may be a computer-readable signal medium, a computer-readable storage medium, or any combination thereof. The computer-readable storage medium may be, for example, but is not limited to, an electric, magnetic, optical, electromagnetic, infrared, or semi-conductive system, apparatus, or component, or any combination thereof. The computer-readable storage medium may include, but is not limited to: an electrical connection having one or more wires, a portable computer magnetic disk, a hard disk, a RAM, a ROM, an erasable programmable read-only memory (EPROM), a flash memory, an optical fiber, a portable compact disk read-only memory (CD-ROM), an optical storage device, a magnetic storage device, or any appropriate combination thereof. In some embodiments, the computer-readable storage medium may be any tangible medium including or storing a program, and the program may be used by or used in combination with an instruction execution system, an apparatus, or a device. In some embodiments, the computer-readable signal medium may include a data signal transmitted in a baseband or as part of a carrier, and stores a computer-readable computer program. A data signal transmitted in such a way may be in a plurality of forms, including, but not limited to, an electromagnetic signal, an optical signal, or any appropriate combination thereof. The computer-readable signal medium may be any computer-readable medium other than a computer-readable storage medium. The computer-readable medium may send, propagate, or transmit a program that is used by or used in combination with an instruction execution system, an apparatus, or a device. The computer program included in the computer-readable medium may be transmitted by using a medium, including but not limited to: a wireless medium, a wired medium, or a combination thereof.

The flowcharts and block diagrams in the accompanying drawings illustrate system architectures, features, and operations that may be implemented by systems, methods, and computer program products according to some embodiments. Each block in the flowcharts or block diagrams may represent a module, a program segment, or a part of code. The module, the program segment, or the part of code includes one or more executable instructions for implementing specified logical functions. The functions marked in the blocks may occur in a sequence different from that marked in the accompanying drawings. For example, two consecutive blocks may be executed in parallel, and may be executed in a reverse order, depending on a function involved. Each block in the block diagrams or flowcharts, and a combination of blocks in the block diagrams or flowcharts may be implemented by using a dedicated hardware-based system configured to perform a specified function or operation, or may be implemented by using a combination of dedicated hardware and a computer program.

A unit described in some embodiments may be implemented in a software manner, or may be implemented in a hardware manner, and the described unit may be configured in a processor. Names of the units do not constitute a limitation on the units.

According some embodiments, a computer-readable medium is provided. The computer-readable medium may be included in the terminal device described in some embodiments, or may exist alone and may not be configured in the terminal device. The computer-readable medium carries one or more computer programs. Based on the one or more computer programs being executed by the terminal device, the terminal device implements the methods in some embodiments.

A person skilled in the art may readily understand that the exemplary implementations described herein may be implemented by using software, or may be implemented by combining software and hardware. Therefore, the technical solutions of some embodiments may be implemented in a form of a software product. The software product may be stored in a non-volatile storage medium (which may be a CD-ROM, a USB flash drive, a removable hard disk, or the like) or on a network, including several instructions for instructing a computing device (which may be a personal computer, a server, a touch terminal, a network device, or the like) to perform the methods according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data processing method, performed by a terminal device, comprising:
negotiating first processing capability information for a service data packet set with a network-side device; and
communicating with the network-side device based on the first processing capability information,
wherein the service data packet set includes a plurality of associated service data packets, and
wherein the communicating with the network-side device includes processing the plurality of associated service data packets.

2. The data processing method according to claim 1, wherein the negotiating comprises:
generating a registration request including second processing capability information of the terminal device for the service data packet set; and
transmitting the registration request to the network-side device to negotiate the first processing capability information.

3. The data processing method according to claim 2, wherein the registration request further indicates whether to enable processing of the service data packet set.

4. The data processing method according to claim 2, further comprising:
generating a protocol data session establishment request including first information indicating whether to enable or disable processing of the service data packet set; and
transmitting the protocol data session establishment request to the network-side device to indicate whether to enable or disable the processing of the service data packet set.

5. The data processing method according to claim 1, wherein the negotiating comprises:
generating a protocol data session establishment request including second processing capability information of the terminal device for the service data packet set; and
transmitting the protocol data session establishment request to the network-side device to negotiate the first processing capability information.

6. The data processing method according to claim 5, wherein the protocol data session establishment request further indicates whether to enable processing of the service data packet set.

7. The data processing method according to claim 5, further comprising:
generating a protocol data session modification request including first information indicating whether to enable or disable processing of the service data packet set; and
transmitting the protocol data session modification request to the network-side device to indicate whether to enable or disable the processing of the service data packet set.

8. The data processing method according to claim 5, further comprising:
generating a new protocol data session establishment request including first information indicating whether to enable or disable processing of the service data packet set; and
transmitting the new protocol data session establishment request to the network-side device to indicate whether to enable or disable the processing of the service data packet set.

9. The data processing method according to claim 1, wherein the negotiating comprises:
including second processing capability information of the terminal device for the service data packet set in a terminal device capability parameter to negotiate the first processing capability information.

10. The data processing method according to claim 9, wherein the including the second processing capability information comprises:
including in a radio access capability parameter of the terminal device, third processing capability information of the terminal device for the service data packet set on a radio access network side; and
including in a core network capability parameter of the terminal device, fourth processing capability information of the terminal device for the service data packet set on a core network side.

11. A data processing apparatus, comprising:
at least one memory configured to store computer program code;
at least one processor configured to read the program code and operate as instructed by the program code, the program code comprising:
negotiation code configured to cause at least one of the at least one processor to negotiate first processing capability information for a service data packet set with a network-side device; and
processing code configured to cause at least one of the at least one processor to communicate with the network-side device based on the first processing capability information,
wherein the service data packet set comprises a plurality of associated service data packets, and
wherein the processing code is configured to process the plurality of associated service data packets in the communication with the network-side device.

12. The data processing apparatus according to claim 11, wherein the negotiation code is further configured to cause at least one of the at least one processor to:
generate a registration request comprising second processing capability information of a terminal device for the service data packet set; and
transmit the registration request to the network-side device to negotiate the first processing capability information.

13. The data processing apparatus according to claim 12, wherein the registration request further indicates whether to enable processing of the service data packet set.

14. The data processing apparatus according to claim 12, further comprising:
generating code configured to cause at least one of the at least one processor to generate a protocol data session establishment request comprising first information indicating whether to enable or disable processing of the service data packet set; and
transmitting code configured to cause at least one of the at least one processor to transmit the protocol data session establishment request to the network-side device to indicate whether to enable or disable the processing of the service data packet set.

15. The data processing apparatus according to claim 11, wherein the negotiation code is configured to cause at least one of the at least one processor to:
generate a protocol data session establishment request comprising second processing capability information of a terminal device for the service data packet set; and
transmit the protocol data session establishment request to the network-side device to negotiate the first processing capability information.

16. The data processing apparatus according to claim 15, wherein the protocol data session establishment request further indicates whether to enable processing of the service data packet set.

17. The data processing apparatus according to claim 15, further comprising:
generating code configured to cause at least one of the at least one processor to generate a protocol data session modification request comprising first information indicating whether to enable or disable processing of the service data packet set; and
transmitting code configured to cause at least one of the at least one processor to transmit the protocol data session modification request to the network-side device to indicate whether to enable or disable the processing of the service data packet set.

18. The data processing apparatus according to claim 15, further comprising:
generating code configured to cause at least one of the at least one processor to generate a new protocol data session establishment request comprising first information indicating whether to enable or disable processing of the service data packet set; and
transmitting code configured to cause at least one of the at least one processor to transmit the new protocol data session establishment request to the network-side device to indicate whether to enable or disable the processing of the service data packet set.

19. The data processing apparatus according to claim 11, wherein the negotiation code is configured to cause at least one of the at least one processor to:
include second processing capability information of a terminal device for the service data packet set in a terminal device capability parameter to negotiate the first processing capability information.

20. A non-transitory computer-readable medium, storing computer code which, when executed by at least one processor, causes the at least one processor to at least:
negotiate first processing capability information for a service data packet set with a network-side device; and
communicate with the network-side device based on the first processing capability information,
wherein the service data packet set comprises a plurality of associated service data packets, and
wherein the communication with the network-side device comprises processing the plurality of associated service data packets.
